(19) United States
(12) Patent Application Publication
(10) Pub. No.: US 2019/0322488 A1
(43) Pub. Date: Oct. 24, 2019

(54) HEALTH MONITORING OF ELEVATOR TENSION MEMBER

(71) Applicant: Otis Elevator Company, Farmington, CT (US)

(72) Inventor: Kyle B. Martin, Avon, CT (US)

(21) Appl. No.: 15/959,660

(22) Filed: Apr. 23, 2018

(51) Int. Cl. B66B 7/12; B66B 7/06; B66B 9/00; B66B 1/34

(52) U.S. Cl. CPC B66B 7/1223; B66B 1/3446; B66B 9/00; B66B 7/062

(57) ABSTRACT

A suspension member for an elevator system includes at least one tension member arranged along a suspension member width and extending longitudinally along a length of the suspension member, each tension member including a plurality of fibers. A jacket material at least partially encapsulates the at least one tension member. One or more conductive elements are enclosed in the jacket material. A method of health monitoring of a suspension member of an elevator system includes connecting a detection circuit to a suspension member of an elevator system. The detection circuit is monitored for one of an open circuit condition or a short condition, indicative of a health condition of the suspension member.

### BACKGROUND

Embodiments disclosed herein relate to elevator systems, and more particularly to load bearing members to suspend and/or drive elevator cars of an elevator system.

Elevator systems are useful for carrying passengers, cargo, or both, between various levels in a building. Some elevators are traction based and utilize load bearing members such as belts or ropes for supporting the elevator car and achieving the desired movement and positioning of the elevator car.

Where a belt is used as a load bearing member, a plurality of tension members are embedded in a common jacket. The jacket retains the tension members in desired positions and provides a frictional load path. Belts typically utilize tension members formed from steel elements and are referred to as coated steel belts, but alternatively may utilize tension members formed from synthetic or natural fibers or other materials, such as carbon fiber reinforced composites, which are referred to as carbon fiber belts. In other elevator systems, tension members are formed into ropes, which in some case may be coated.

Advanced elevator load bearing members, such as coated steel belts, carbon fiber belts, or coated high performance ropes have a wear mechanism in which the protective jacket or coating is abraded away, exposing the tension members and thus requiring replacement of the load bearing members. Further, some code bodies require that elevator systems utilizing non-metallic fiber belts, such as carbon fiber belts, have a health monitoring system in place to monitor the condition of the belt.

### BRIEF DESCRIPTION

In one embodiment, a suspension member for an elevator system includes at least one tension member arranged along a suspension member width and extending longitudinally along a length of the suspension member, each tension member including a plurality of fibers. A jacket material at least partially encapsulates the at least one tension member. One or more conductive elements are enclosed in the jacket material.

Additionally or alternatively, in this or other embodiments the one or more conductive members are located and configured such that as the jacket material wears due to operation of the elevator system. The one or more conductive elements are exposed prior to the at least one tension member being exposed.

Additionally or alternatively, in this or other embodiments the at least one tension member is formed from the plurality of fibers suspended in a matrix material.

Additionally or alternatively, in this or other embodiments the plurality of fibers are formed from one or more of carbon fibers, glass fibers or aramid fibers.

Additionally or alternatively, in this or other embodiments the one or more conductive elements are located in the jacket material, separated from the at least one tension member by a selected distance.

Additionally or alternatively, in this or other embodiments the one or more conductive elements are wrapped around the at least one tension member.

In another embodiment, a method of health monitoring of a suspension member of an elevator system includes connecting a detection circuit to a suspension member of an elevator system. The suspension member includes at least one tension member arranged along a suspension member width and extending longitudinally along a length of the suspension member, each tension member including a plurality of fibers, a jacket material at least partially encapsulating the at least one tension member, and one or more conductive elements enclosed in the jacket material. The detection circuit is monitored for one of an open circuit condition or a short condition, indicative of a health condition of the suspension member.

Additionally or alternatively, in this or other embodiments the health condition is wear of the jacket material.

Additionally or alternatively, in this or other embodiments the one or more conductive elements contact a sheave of the elevator system resulting in detection of the one of the open circuit condition or the short condition.

Additionally or alternatively, in this or other embodiments the one of the open circuit condition or the short condition is communicated to an elevator control system.

Additionally or alternatively, in this or other embodiments the one or more conductive elements are located in the jacket material, separated from the at least one tension member by a selected distance.

Additionally or alternatively, in this or other embodiments the one or more conductive elements are wrapped around the at least one tension member.

In yet another embodiment, an elevator system includes a hoistway, an elevator car located in and movable along the hoistway, and a suspension member operably connected to the elevator car to move the elevator car along the hoistway. The suspension member includes at least one tension member arranged along a suspension member width and extending longitudinally along a length of the suspension member, each tension member including a plurality of fibers. A jacket material at least partially encapsulates the at least one tension member. One or more conductive elements are enclosed in the jacket material. A detection circuit is operably connected to the one or more conductive elements. The detection circuit is configured to detect one of an open circuit condition or a short condition, indicative of a health condition of the suspension member.

Additionally or alternatively, in this or other embodiments the health condition is wear of the jacket material.

Additionally or alternatively, in this or other embodiments the one or more conductive elements contact a sheave of the elevator system resulting in detection of the one of the open circuit condition or the short condition.

Additionally or alternatively, in this or other embodiments the one or more conductive elements are located in the jacket material, separated from the at least one tension member by a selected distance.

Additionally or alternatively, in this or other embodiments the one or more conductive elements are wrapped around the at least one tension member.

### BRIEF DESCRIPTION OF THE DRAWINGS

The following descriptions should not be considered limiting in any way. With reference to the accompanying drawings, like elements are numbered alike:

FIG. 1 is a schematic illustration of an embodiment of a representative elevator system;

FIG. 2 is cross-sectional view of an embodiment of a belt;

FIG. 3A is a cross-sectional view of an embodiment of a tension member for a belt;

FIG. 3B is a cross-sectional view of another embodiment of a tension member of a belt;

FIG. 4 is another cross-sectional view of an embodiment of a tension member of a belt;

FIG. 5 is a schematic illustration of an embodiment of a detection circuit for a belt of an elevator system;

FIG. 6 is another schematic illustration of an embodiment of a detection circuit for a belt of an elevator system; and

FIG. 7 is yet another schematic illustration of an embodiment of a detection circuit for a belt of an elevator system.

### DETAILED DESCRIPTION

A detailed description of one or more embodiments of the disclosed apparatus and method are presented herein by way of exemplification and not limitation with reference to the Figures.

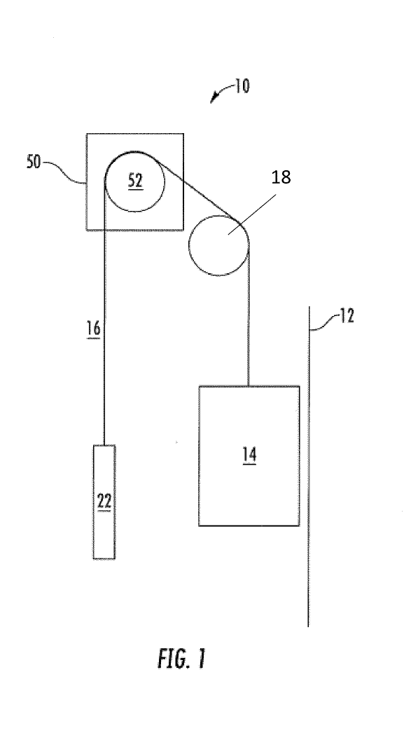

Shown in FIG. 1 is a schematic view of an exemplary traction elevator system 10. Features of the elevator system 10 that are not required for an understanding of the present invention (such as the guide rails, safeties, etc.) are not discussed herein. The elevator system 10 includes an elevator car 14 operatively suspended or supported in a hoistway 12 with one or more suspension members, for example belts 16. While the following description, belts 16 are the suspension members utilized in the elevator system, one skilled in the art will readily appreciate that the present disclosure may be utilized with other suspension members, such as ropes. The one or more belts 16 interact with sheaves 18 and 52 to be routed around various components of the elevator system 10. Sheave 18 is configured as a diverter, deflector or idler sheave and sheave 52 is configured as a traction sheave, driven by a machine 50. Movement of the traction sheave 52 by the machine 50 drives, moves and/or propels (through traction) the one or more belts 16 that are routed around the traction sheave 52. Diverter, deflector or idler sheaves 18 are not driven by a machine 50, but help guide the one or more belts 16 around the various components of the elevator system 10. The one or more belts 16 could also be connected to a counterweight 22, which is used to help balance the elevator system 10 and reduce the difference in belt tension on both sides of the traction sheave during operation. The sheaves 18 and 52 each have a diameter, which may be the same or different from each other.

In some embodiments, the elevator system 10 could use two or more belts 16 for suspending and/or driving the elevator car 14 In addition, the elevator system 10 could have various configurations such that either both sides of the one or more belts 16 engage the sheaves 18, 52 or only one side of the one or more belts 16 engages the sheaves 18, 52. The embodiment of FIG. 1 shows a 1:1 roping arrangement in which the one or more belts 16 terminate at the car 14 and counterweight 22, while other embodiments may utilize other roping arrangements.

The belts 16 are constructed to meet belt life requirements and have smooth operation, while being sufficiently strong to be capable of meeting strength requirements for suspending and/or driving the elevator car 14 and counterweight 22.

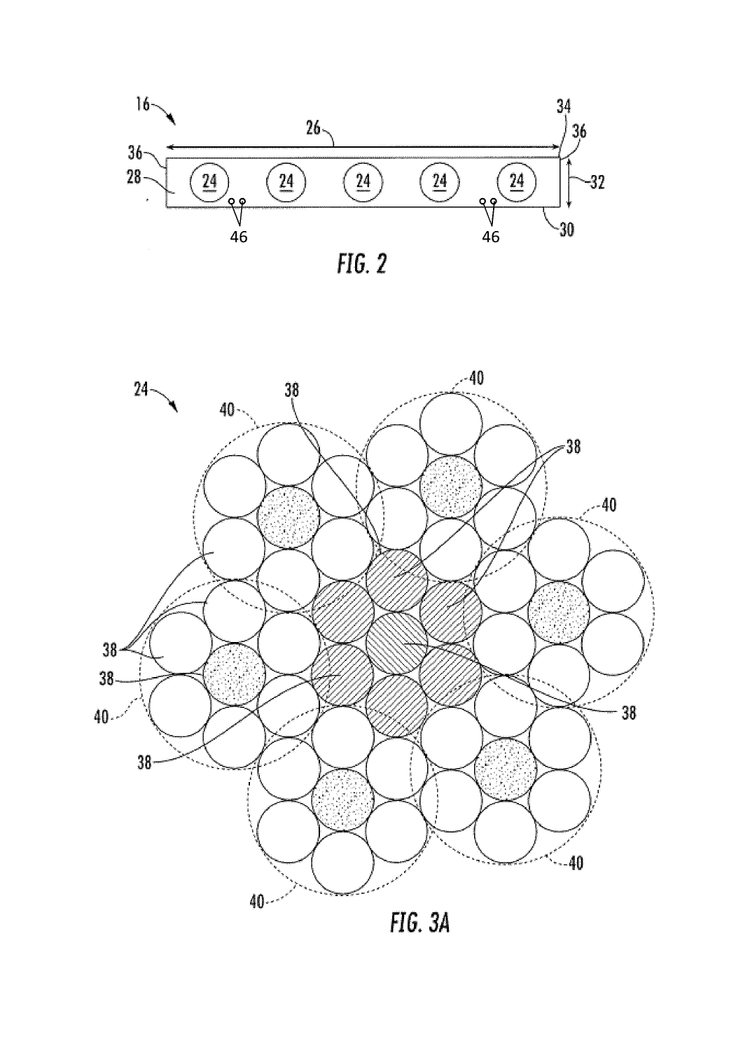

FIG. 2 provides a cross-sectional schematic of an exemplary belt 16 construction or design. The belt 16 includes a plurality of tension members 24 extending longitudinally along the belt 16 and arranged across a belt width 26. The tension members 24 are at least partially enclosed in a jacket material 28 to restrain movement of the tension members 24 in the belt 16 with respect to each other and to protect the tension members 24. The jacket material 28 defines a traction side 30 configured to interact with a corresponding surface of the traction sheave 52. Exemplary materials for the jacket material 28 include the elastomers of thermoplastic and thermosetting polyurethanes, thermoplastic polyester elastomers, ethylene propylene diene elastomer, chloroprene, chlorosulfonyl polyethylene, ethylene vinyl acetate, polyamide, polypropylene, butyl rubber, acrylonitrile butadiene rubber, styrene butadiene rubber, acrylic elastomer, fluoroelastomer, silicone elastomer, polyolefin elastomer, styrene block and diene elastomer, natural rubber, or combinations thereof. Other materials may be used to form the jacket material 28 if they are adequate to meet the required functions of the belt 16. For example, a primary function of the jacket material 28 is to provide a sufficient coefficient of friction between the belt 16 and the traction sheave 52 to produce a desired amount of traction therebetween. The jacket material 28 should also transmit the traction loads to the tension members 24. In addition, the jacket material 28 should be wear resistant and protect the tension members 24 from impact damage, exposure to environmental factors, such as chemicals, for example.

The belt 16 has a belt width 26 and a belt thickness 32, with an aspect ratio of belt width 26 to belt thickness 32 greater than one. The belt 16 further includes a back side 34 opposite the traction side 30 and belt edges 36 extending between the traction side 30 and the back side 34. While five tension members 24 are illustrated in the embodiment of FIG. 2, other embodiments may include other numbers of tension members 24, for example, 6, 10 or 12 tension members 24. Further, while the tension members 24 of the embodiment of FIG. 2 are substantially identical, in other embodiments, the tension members 24 may differ from one another. While a belt 16 with a rectangular cross-section is illustrated in FIG. 2, it is to be appreciated that belts 16 having other cross-sectional shapes are contemplated within the scope of the present disclosure.

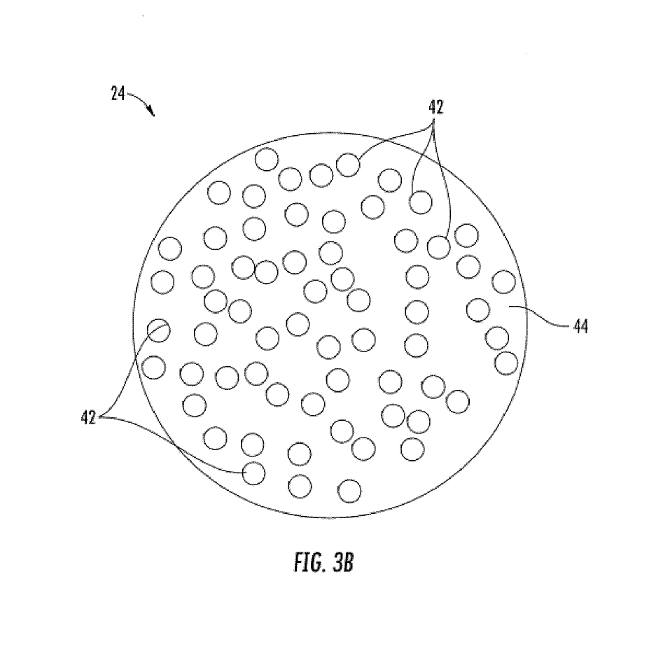

Referring now to FIG. 3A, the tension member 24 may be a plurality of wires 38, for example, steel wires 38, which in some embodiments are formed into one or more strands 40. In other embodiments, such as shown in FIG. 3B, the tension member 24 may include a plurality of fibers 42, such as carbon fiber, glass fiber aramid fiber, or their combination, disposed in a matrix material 44. Materials such as polyurethane, vinylester, or epoxy may be utilized as the matrix material, as well as other thermoset materials and, for example, thermoset polyurethane materials. While a circular cross-sectional tension member geometry is illustrated in the embodiment of FIG. 3B, other embodiments may include different tension member cross-sectional geometries, such as rectangular or ellipsoidal. While the cross-sectional geometries of the tension members 24 in FIG. 2 are shown as identical, in other embodiment the tension members' cross-sectional geometries may differ from one another.

To reliably monitor wear of the belt 16, the belt 16 includes one or more conductive members 46. In some embodiments, such as in FIG. 2, the conductive members 46 are, for example, metallic wires or other elements embedded in the jacket material 28 and extending along a length of the belt 16. In some embodiments, as shown, the conductive members 46 are located between the tension members 24 and the traction side 30 of the belt 16. While four conductive members 46 are shown in FIG. 2, it is to be appreciated that other quantities and/or locations of conductive members 46 may be utilized.

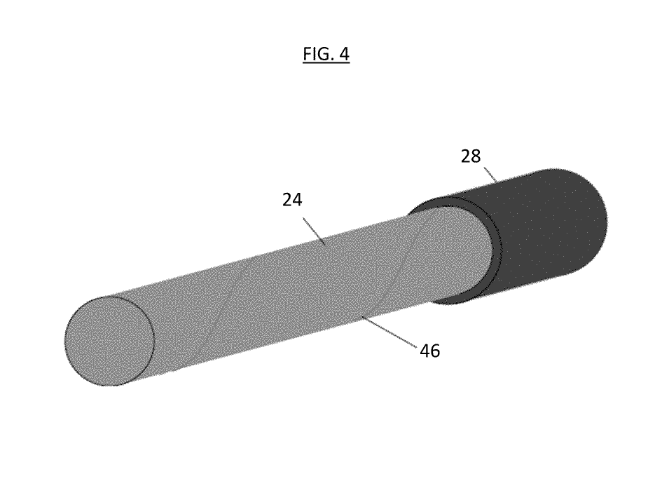

In other embodiments, such as shown in FIG. 4, the conductive members 46 are located at, or wrapped around the tension members 24. In some embodiments of belts 16, each of the tension members 24 may include conductive members 46, while in other embodiments only selected tension members 24 include conductive members 46. While in the embodiment of FIG. 4 the conductive member 46 is a wire-like element wrapped around the tension member 24, in other embodiments other configurations, such as a conductive coating of the tension element 24 may be utilized to act as the conductive member 46.

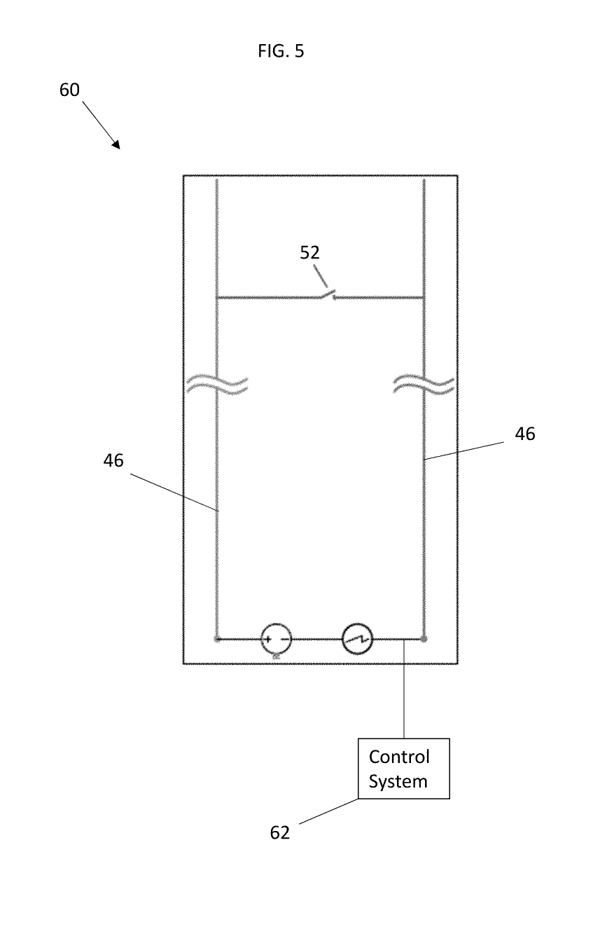

A detection circuit 60 is operably connected to the conductive members 46, with an example configuration shown in FIG. 5. In this embodiment, the detection circuit 60 is connected to two conductive members 46 of the belt 16. As the jacket material 28 wears due to, for example, operation of the elevator system 10, two or more of the conductive members 46 may be exposed as the jacket material 28 wears away. As such, one or more of the conductive members 46 may contact a sheave 18, in particular the traction sheave 52. When the conductive member 46 contacts the traction sheave 52, the detection circuit 60 detects shorting across the traction sheave 52. When the shorting is detected, the detection circuit 60 may signal an elevator control system 62 that inspection of and/or maintenance or replacement of the belt 16 is required. In some embodiments, the elevator control system 62 may utilize elevator car 14 position or other information at the time of the short detection to determine a location on the belt 16 in need of inspection.

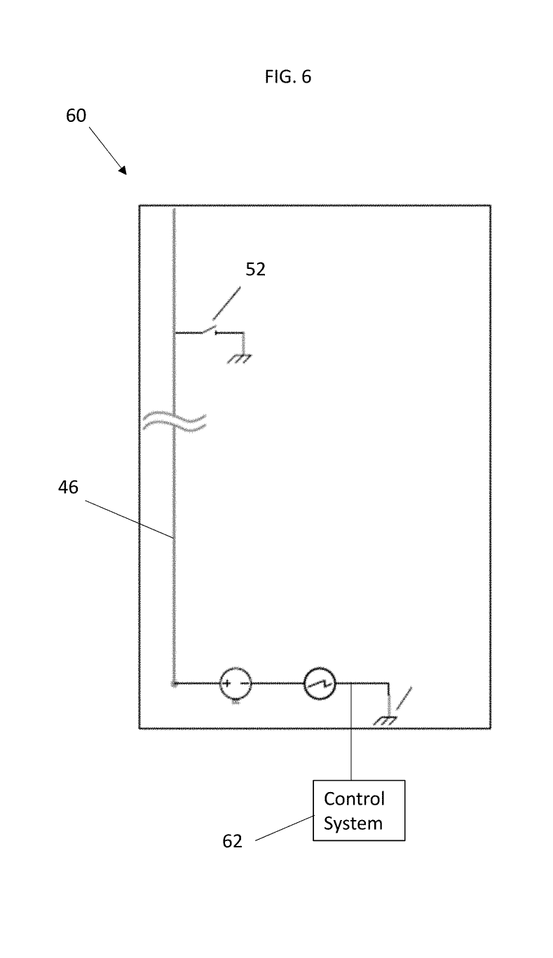

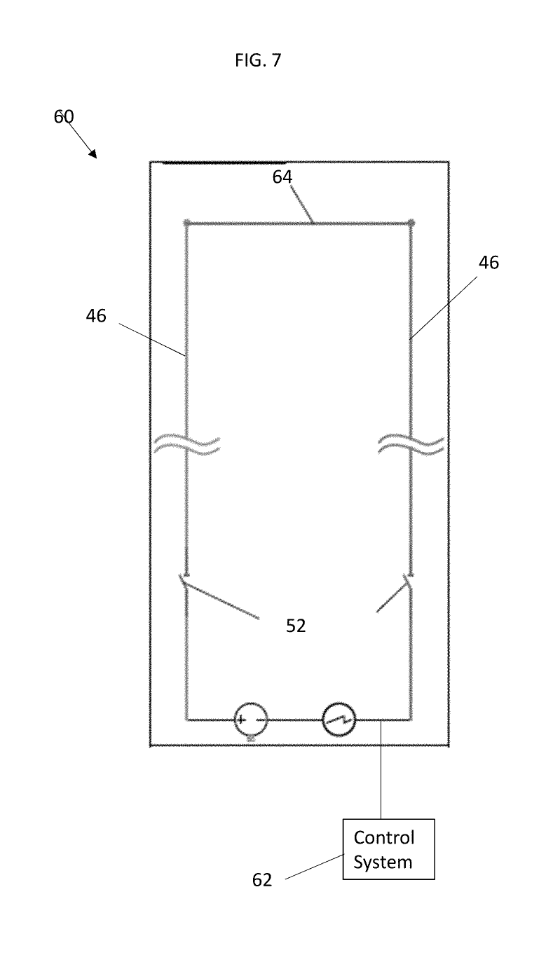

Other embodiments of detection circuits 60 are illustrated in FIGS. 6 and 7. In the embodiment of FIG. 6, the detection circuit 60 utilizes only one conductive member 46 and is grounded to, for example, the traction sheave 52. The detection circuit 60 of FIG. 6 then detects a short across the traction sheave 52 (ground) when the jacket material 28 is worn or damaged allowing contact of the conductive member 46 to the traction sheave 52.

In the embodiment of FIG. 7, the detection circuit 60 utilizes two conductive members 46 of the belt 16, which are connected at, for example, a connector 64 one end of the belt 16. The detection circuit 60 of this configuration opens when the jacket material 28 is worn or damaged allowing contact of the conductive member 46 to the traction sheave 52.

The belts 16 including conductive members 46 connected to the detection circuit 60 allow for health monitoring of belts 16, especially those with non-metallic tension members 24. Further, it may be shown trough testing and analysis that for such belts 16, jacket material 28 wear is indicative of overall belt 16 life, in that in such belts 16 the jacket material 28 will wear prior to any loss of strength in the tension member 24.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A suspension member for an elevator system, comprising:
at least one tension member arranged along a suspension member width and extending longitudinally along a length of the suspension member, each tension member including a plurality of fibers;
a jacket material at least partially encapsulating the at least one tension member; and
one or more conductive elements enclosed in the jacket material.

2. The suspension member of claim 1, wherein the one or more conductive members are located and configured such that as the jacket material wears due to operation of the elevator system, the one or more conductive elements are exposed prior to the at least one tension member being exposed.

3. The suspension member of claim 1, wherein the at least one tension member is formed from the plurality of fibers suspended in a matrix material.

4. The suspension member of claim 1, wherein the plurality of fibers are formed from one or more of carbon fibers, glass fibers or aramid fibers.

5. The suspension member of claim 1, wherein the one or more conductive elements are disposed in the jacket material, separated from the at least one tension member by a selected distance.

6. The suspension member of claim 1, wherein the one or more conductive elements are wrapped around the at least one tension member.

7. A method of health monitoring of a suspension member of an elevator system, comprising:
connecting a detection circuit to a suspension member of an elevator system, the suspension member including:
at least one tension member arranged along a suspension member width and extending longitudinally along a length of the suspension member, each tension member including a plurality of fibers;
a jacket material at least partially encapsulating the at least one tension member; and
one or more conductive elements enclosed in the jacket material; and
monitoring the detection circuit for one of an open circuit condition or a short condition, indicative of a health condition of the suspension member.

8. The method of claim 7, wherein the health condition is wear of the jacket material.

9. The method of claim 7, wherein the one or more conductive elements contact a sheave of the elevator system resulting in detection of the one of the open circuit condition or the short condition.

10. The method of claim 7, further comprising communicating the one of the open circuit condition or the short condition to an elevator control system.

11. The method of claim 7, wherein the one or more conductive elements are disposed in the jacket material, separated from the at least one tension member by a selected distance.

12. The method of claim 7, wherein the one or more conductive elements are wrapped around the at least one tension member.

13. An elevator system, comprising:
a hoistway;
an elevator car disposed in and movable along the hoistway;
a suspension member operably connected to the elevator car to move the elevator car along the hoistway, the suspension member including:
at least one tension member arranged along a suspension member width and extending longitudinally along a length of the suspension member, each tension member including a plurality of fibers;
a jacket material at least partially encapsulating the at least one tension member; and
one or more conductive elements enclosed in the jacket material; and
a detection circuit operably connected to the one or more conductive elements, the detection circuit configured to detect one of an open circuit condition or a short condition, indicative of a health condition of the suspension member.

14. The elevator system of claim 13, wherein the health condition is wear of the jacket material.

15. The elevator system of claim 13, wherein the one or more conductive elements contact a sheave of the elevator system resulting in detection of the one of the open circuit condition or the short condition.

16. The elevator system of claim 13, wherein the one or more conductive elements are disposed in the jacket material, separated from the at least one tension member by a selected distance.

17. The elevator system of claim 13, wherein the one or more conductive elements are wrapped around the at least one tension member.
